(19) United States
(12) Patent Application Publication
(10) Pub. No.: US 2018/0022543 A1
(43) Pub. Date: Jan. 25, 2018

(54) UNDERGROUND COLLECTION CONTAINER

(71) Applicant: MOLOK OY, Nokia (FI)

(72) Inventor: Hannu JOKINEN, Nokia (FI)

(21) Appl. No.: 15/547,598

(22) PCT Filed: Jan. 25, 2016
(86) PCT No.: PCT/FI2016/050032

§ 371 Date: Jul. 31, 2017

(30) Foreign Application Priority Data
Jan. 30, 2015 (FI) 20155064

(51) Int. Cl. B65F 1/14; B30B 15/32; B30B 1/32

(52) U.S. Cl. CPC B65F 1/1405; B65F 1/1447; B30B 1/32; B30B 15/32; B65F 2240/156; B65F 2240/1126; B65F 2240/12

(57) ABSTRACT

A hydraulic compactor configured to be fastened to the cover structure of an underground collection container, for compacting waste materials. The hydraulic compactor includes a filling opening equipped with a hatch, via which the waste material may be entered into a compressing space inside the compactor, a press member being provided above the compressing space and being movable in the vertical direction inside the compactor. The press member presses the waste material fed into the compressing space against the bottom plate of the compactor. The bottom plate of the compactor is a hydraulic bottom plate opening in the horizontal direction, via which the waste material compressed in the compressing space is dropped into the underground collection container. The present disclosure also relates to an underground collection container comprising a compactor.

### FIELD

The present disclosure relates to a compactor for compressing waste material to be entered in an underground collection container, and an underground collection container comprising a compactor.

### BACKGROUND

For recycling, collection containers or bins are provided at recycling points and residential waste disposal points. Recycling is an efficient way to reduce the quantity of mixed waste and to recover existing materials. Collectible and recyclable paperboard, however, has a relatively light weight and is in such a form, for example in the form of corrugated board, cartons, cardboard packages, pizza boxes, egg cartons, and disposable cardboard tableware, that the board is not placed tightly in the collection container. The same problems are involved in the collection of plastic materials from households as in the collection of paperboard. Plastic, too, has a relatively light weight and is in such a form, for example in the form of washing agent packages, such as shampoo bottles, bottles and cans, that it is not placed tightly in the collection container either. Therefore, the collection containers are quickly filled up but do not contain a large quantity by weight of recyclable paperboard or plastic. The emptying of such collection containers is not cost efficient, because the emptying costs are the same, irrespective of the quantity of collectible waste in the container.

### BRIEF SUMMARY

It is an aim of the disclosed embodiments to provide a compactor in an underground collection container, for compacting waste material to be entered in the container so that the collecting capacity of the underground collection container could be better utilized.

The disclosed embodiments relate to a hydraulic compactor configured to be fastened to the cover structure of an underground collection container, for compacting waste materials. The hydraulic compactor comprises a filling opening equipped with a hatch, via which opening the waste material may be entered in a compressing space inside the compactor. A press member is provided above the compressing space movable in the vertical direction within the compactor, for compacting waste material entered in the compressing space against a bottom plate of the compactor. The bottom plate is a hydraulic bottom plate openable in the horizontal direction, via which the waste material compacted in the compressing space by the press member is configured to be dropped into the underground collection container.

In an advantageous embodiment, the hatch of the filling opening of the compactor may be locked, and the press member will start to compact the waste material after the hatch of the compactor has locked, or after the hatch of the compactor has been locked by applying a separate actuating switch. In another advantageous embodiment, a waste material limiting switch will trigger the opening of the hydraulic bottom plate.

The disclosed embodiments also relate to an underground collection container comprising a hydraulic compactor configured to be fastened to the cover structure of an underground collection container, for compacting waste materials. The hydraulic compactor comprises a filling opening equipped with a hatch, via which opening the waste material may be entered in a compressing space inside the compactor. A press member is provided above the compressing space movable in the vertical direction within the compactor, for compacting waste material entered in the compressing space against a bottom plate of the compactor. The bottom plate is a hydraulic bottom plate openable in the horizontal direction, via which the waste material compacted in the compressing space by the press member is configured to be dropped into the underground collection container.

In an advantageous embodiment, the hatch of the filling opening of the compactor may be locked, and the press member will start to compact the waste material after the hatch of the compactor has locked, or after the hatch of the compactor has been locked by applying a separate actuating switch. In another advantageous embodiment, a waste material limiting switch will trigger the opening of the hydraulic bottom plate. In yet another advantageous embodiment, the underground collection container can be buried entirely below the surface of the ground. In yet another advantageous embodiment, the underground collection container is configured to remain partly below the surface of the ground. In yet another advantageous embodiment, the hydraulic compactor is fastened to the cover structure in a fixed manner by at least one fastening member. In yet another advantageous embodiment, the hydraulic compactor is mounted on top of the cover structure. In yet another advantageous embodiment, part of the hydraulic compactor is within the underground collection container. In yet another advantageous embodiment, a lifting receiver comprised by the underground collection container is fastened to the hydraulic compactor in a fixed manner.

### DESCRIPTION OF THE DRAWINGS

The disclosed embodiments will now be described in more detail in connection with advantageous embodiments with reference to the appended drawings, in which:

FIG. 1a shows a cross-sectional side view of an underground collection container that comprises a waste compactor according to an embodiment of the invention;

FIG. 1b shows a cross-sectional front view of the underground collection container of FIG. 1, including the compactor;

FIG. 2a shows a cross-sectional front view of an underground collection container comprising a waste compactor according to an embodiment of the invention;

FIG. 2b shows a cross-sectional side view of the underground collection container of FIG. 2a, including the compactor;

FIG. 3a shows a compactor for an underground collection container according to an embodiment of the invention; and

FIG. 3b illustrates the operation of the fastening mechanism of a compactor according to an embodiment of the invention.

### DETAILED DESCRIPTION

In this context, the term waste material comprises any recyclable material suitable to be compacted. Such waste material includes, in connection with this invention, particularly paperboard and recoverable plastic waste. However, the material to be compacted can be another material as well.

In this context, the term paperboard comprises any recyclable paperboard and cardboard material, such as folding boxboard, bleached chipboard, solid chemical pulp board, liquid packaging board, exterior package boards, special paperboards, and corrugated board.

In this context, the term recoverable plastic waste comprises any packaging plastics suitable for the collection of consumer plastic waste, such as PE plastic products, that is, detergent packages, food packages, such as margarine boxes, yoghurt cups, etc., as well as bottles and cans, etc.

In relation to the size of the recyclable waste container or bin, the mass of recyclable material fitting in it often remains small with respect to the quantity of waste material that could be collected in the collection container if the waste material were compacted. In other words, the collecting capacity of the collection container, such as an underground collection container, cannot be utilized in full, if the waste material to be recycled cannot be compacted e.g. by compressing. The underground collection containers may be collection containers similar to Deep Collection™ containers. By compressing recyclable material, large sums can be saved in the transportation costs of waste material, because after the compressing, the need for emptying the collection container is reduced and the intervals for emptying become longer.

In connection with underground collection containers, it has not been possible so far to compress recyclable waste to a more compact form. Instead, there are baling presses, such as press containers, for compressing various materials and simultaneously compacting them into the receiver part of the container to be emptied. However, such press containers are large and thereby set high demands on their location. Moreover, training may be required for operating them.

In the solution according to the invention, the waste material is placed more tightly in a collection container, for example an underground collection container, when a waste compactor is integrated in the collection container. The waste compactor integrated in the collection container provides advantages, particularly in underground collection containers with a high collecting capacity, wherein the collecting capacity extends to an underground receiver part in addition to a possible overground collecting part. The underground collection container is either a semi-underground or full-underground waste collection container having a large capacity. The underground collection container according to the invention, comprising a waste compactor, comprises a cover structure, a frame well and a lifting bag or a lifting receiver. Hereinbelow, the term lifting receiver refers to both lifting bags and lifting receivers. In this context, the term cover structure may refer to any structure on top of the underground collection container, for example merely a cover or a cover plate on top of the filling opening of the underground collection container, but the cover structure may also refer to another overground part of the underground collection container in addition to the cover, to be lifted together with the compactor when the collection container is emptied. The frame well constitutes the receiver of the underground collection container. The frame well may be made of plastic, such as a rotationally molded frame well of polyethylene, or of metal or concrete. The frame well may be completely water-tight, and its filling opening may be ground flush, wherein the whole frame well is below the surface of the ground. Alternatively, the filling opening may be above the ground, for example at a suitable height in view of the feeding level, and also at a safe height, for example at a height of about 1.1 meters from the surface of the ground. Thus, the frame well is partly below the surface of the ground and partly above the surface of the ground. The lifting receiver to be placed in the frame well may be made of any suitable material. For example, the lifting bag may be made of strong woven polypropylene fabric or PVC. The top part of the lifting bag may be equipped with a lifting collar, for example an aluminium lifting collar with lifting lugs, and the bottom part can be equipped with a trigger releasing mechanism. In this context, the feeding opening refers to the open top of the collection container, from which the waste can be entered into the collection container.

According to the invention, a hydraulic waste compactor is installed on top of the underground collection container, for example in the cover structure of the underground collection container, above or partially within the feeding opening of the collection container. The material to be entered is fed via the feeding opening of the waste compactor into the compressing space in the waste compactor. The waste compactor applies the press member to compact the material in the compressing space, and the hydraulic bottom plate of the compactor is then opened and the press member pushes the compacted material bale via the feeding opening into the underground collection container. The bottom plate, i.e. the bottom structure, of the compactor is opened hydraulically by moving the bottom structure, i.e. the bottom plate, of the compactor horizontally in the lateral direction, that is, in a direction transverse to the depth direction of the underground collection container.

The hydraulic waste compactor is placed in the cover structure of the collection container, e.g. underground collection container, in such a way that when the openable bottom plate of the waste compactor is opened, the compressed waste can be fed from the waste compactor to the underground collection container. The hydraulic waste compactor may have been fastened to the cover structure in a fixed manner by fastening members, such as bolts or the like. Underground collection containers equipped with a fixed waste compactor can be emptied by applying a lifting hook of a crane of a waste collection truck to grip a lifting eye at the top of the compactor. At the same time, the crane lifts up the compactor with the cover structure, and the lifting receiver fixed to the compactor. This assembly is lifted on top of the receiving opening of a waste collection truck, and the lifting receiver is emptied via its bottom into the waste collection truck. After this, the bottom of the lifting receiver is closed, and the compactor with the cover structure and the lifting receiver is lifted back onto the frame of the underground collection container, the lifting receiver is placed in the frame well, the cover structure is put in place, and the compactor is connected to a power supply mains. Before the emptying, the hydraulic compactor is disconnected from the power supply mains. It is also possible that the waste compactor is fastened to the cover structure in a detachable way. In such a case, an anchor post may be provided next to the collection container, to which post the compactor may be fastened by means of a fixing arm. Thus, the compactor is removable, for example pivotable, on and off the cover structure as needed. Hinge structures are thus provided e.g. between the fixing arm and the post. Pivoting off may be necessary, for example, for the time of emptying of the underground collection container.

The hydraulic waste compactor comprises a waste filling opening that is openable and closable in the side direction by a hatch or a corresponding structure. The waste filling opening is advantageously arranged at such a height from the ground that feeding waste into the compactor is ergonomically advantageous but the safety aspect is taken into account as well. The height of the bottom edge of the waste filling opening may be, for example, 1.1 m from the ground, corresponding to the height of the frame well of the underground collection container remaining partly above the surface of the ground. The waste filling opening opens into the compressing space whose bottom is the hydraulic bottom plate of the waste compactor. The compressing space may extend partly to the inside of the collection container (frame well); in other words, the filling opening equipped with a hatch is in the top part of the compressing space. A press member i.e. a pressure foot movable in the vertical direction is provided inside the compactor, above the compressing space, for pressing the supplied material downwards against the bottom plate. After a sufficient quantity of compressed material has been accumulated, the compactor will detect, e.g. by means of a waste material limiting switch provided in the structure of the compactor, that the path of the press member has decreased below a predetermined limit; that is, the press no longer goes to a sufficiently low position but remains above a set level; the waste material prevents it from going to a sufficiently low position. The waste material limiting switch will trigger, i.e. make the compactor unlock the hydraulic bottom plate, whereby the press member will push the compacted material downwards through an opening at the bottom of the compactor into the underground collection container. The press member is configured to generate a sufficient compressive force downwards, towards the underground collection container and the bottom plate, for compressing the waste material. Such a compressive force can be, for example 4 to 6 tons, such as 5 tons. The compactor only works when the hatch of the waste filling opening is closed. The closure of the hatch can be secured by any known electronic lock or possibly also by a mechanical arrangement suitable for use for such security purpose. Closing the hatch may act as a mechanism for switching the compactor automatically on. Thus, no separate actuating switch is needed for turning on the compactor, but the compactor is turned on when the hatch is locked. It is also possible that the compactor comprises an actuating switch, e.g. a press button, and the hatch of the compactor is locked by applying this actuating switch.

The frame of the compactor may be made of a metal, for example stainless steel, as well as the press member and the bottom plate. Thus, the hydraulic compactor comprises all the equipment and connections needed for carrying out the compressing after the locking of the hatch, for releasing the bottom plate, for securing the locking of the hatch, and for connecting the presses to the power supply mains. The compactor can also comprise a lifting eye or a corresponding structure for lifting the compactor, the cover structure and the lifting receiver from the top of the collection container for emptying.

In other words, when the press member goes down from above onto the recyclable paperboard or plastic inside the compactor, the recyclable paperboard or plastic is pressed against the bottom of the compactor and assumes a smaller volume. When the compacted mass bales are fed by the compactor into the collection container, more material to be collected can be received in the collection container than if uncompacted recyclable material were introduced in it. Thanks to the compactor, the collecting capacity of the collection container is increased.

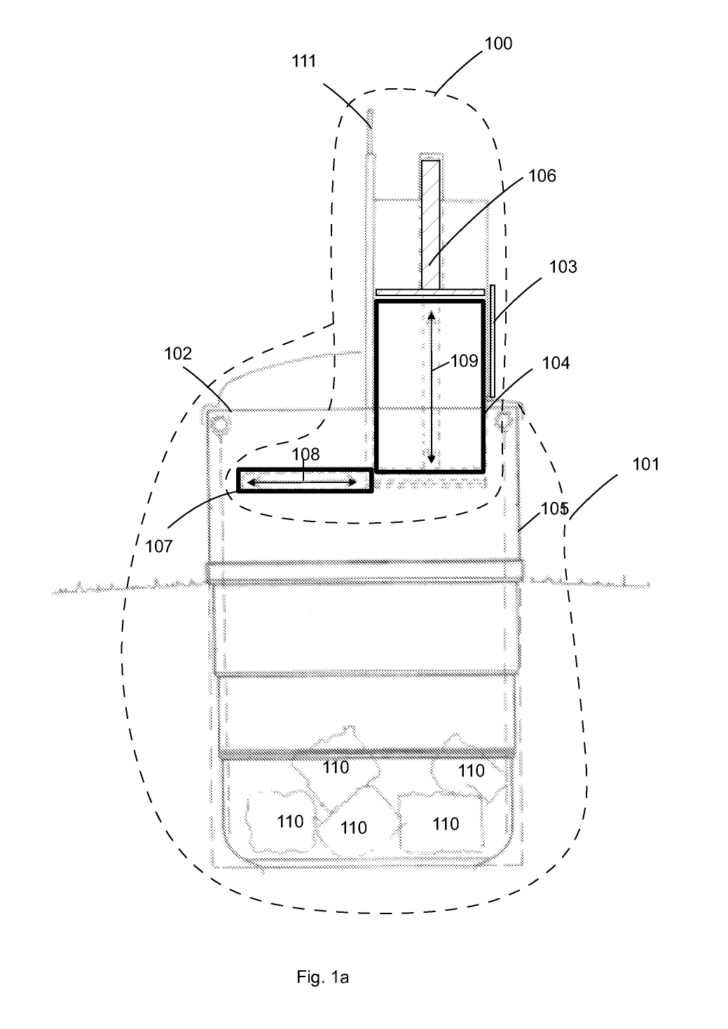

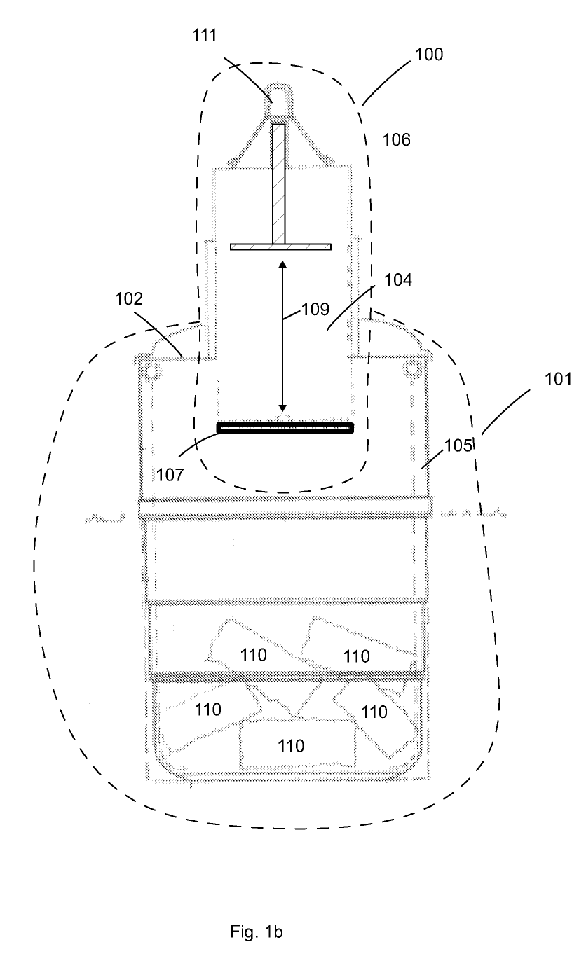

FIG. 1a shows a cross-sectional side view of an underground collection container 101 comprising a waste compactor 100 according to an embodiment of the invention. In the embodiment, the waste compactor 100 is integrated in the cover structure 102 of the underground collection container 101. In this embodiment, the underground collection container 101 is partly above the surface of the ground. FIG. 1 shows the hatch 103 of the waste compactor 100 in front of the filling opening (not shown), a compressing space 104 extending to the top part of the frame well 105 (part of the compactor 100 being below the surface of the ground), the press member 106 above the compressing space 104, and the bottom of the compressing space 104, i.e. the hydraulic bottom plate 107 of the compactor 100. Furthermore, the figure shows the bottom plate 107, the horizontal direction 108 of movement and the vertical direction 109 of movement of the press member 106. The compacted bales 110 of collected materials, produced by the compactor 100 and introduced in the underground collection container 101, are also shown in FIG. 1a. FIG. 1a also shows a lifting eye 111 for emptying the collection container 101.

The compactor 100 comprises the structures and connections needed to secure the bottom plate 107 firmly to the bottom part of the compactor 100 during the compacting, for enabling the pressing, and for opening the bottom plate 107 for feeding the material bale 110. The compactor 100 also comprises electrical connecting means for receiving e.g. an electrical wire or a plug for receiving an electrical wire. The electrical connecting means are not shown in this figure.

FIG. 1b shows a cross-sectional front view of the underground collection container 101 of FIG. 1a, comprising a compactor 100.

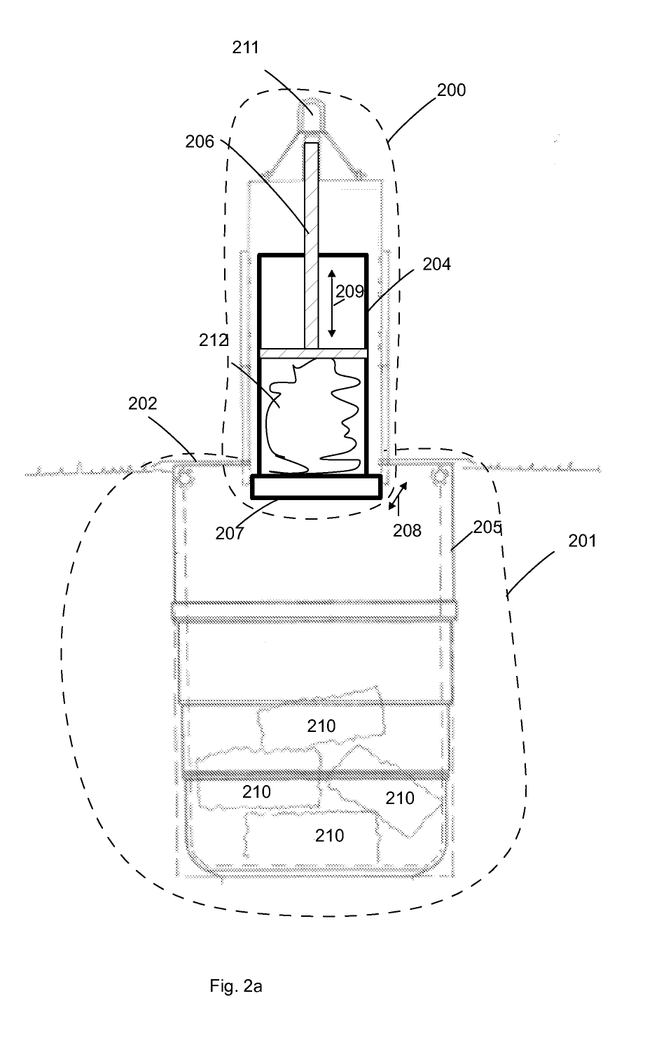

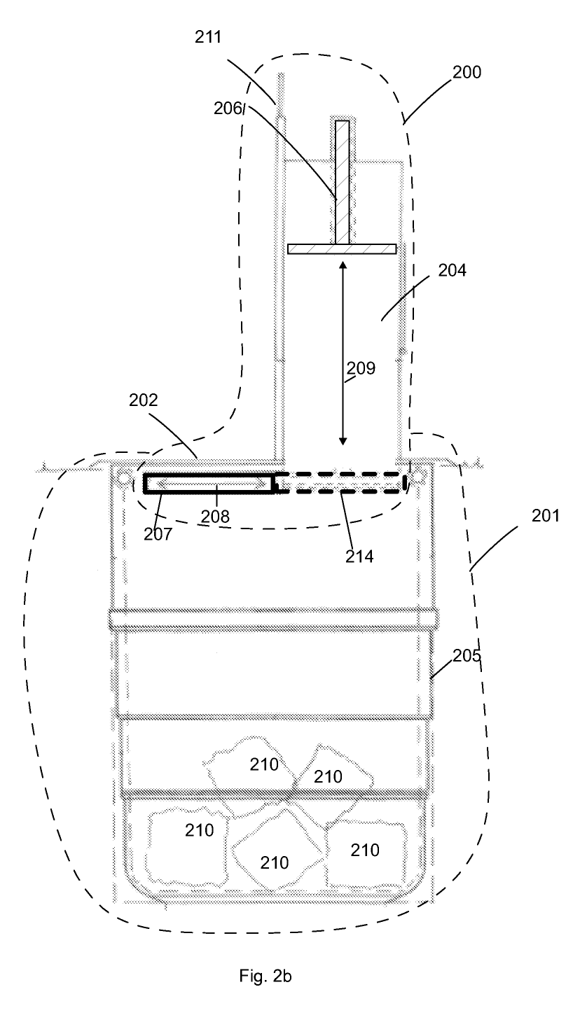

FIG. 2a shows a cross-sectional front view of an underground collection container 201 comprising a waste compactor 200 according to an embodiment of the invention. In this embodiment, the waste compactor 200 is integrated in the cover structure 202, i.e. the cover, of the underground collection container 201. In this embodiment, the underground collection container 201 is totally below the surface of the ground; that is, the whole frame well 205 of the underground collection container 201 is below the surface of the ground. In FIG. 2a, the compressing space 204 extends to the level of the frame well 205, that is, to the level of the feeding opening of the collection container 201, seen from the side. Thus, the whole compactor 200 is above the ground surface. In this figure, the press member 206 is shown in the compressing state (that is, the press member has been lowered towards the bottom plate 207) and it is pressing the material 202 fed into the compressing space 204 towards the bottom of the compressing space 204, that is, the hydraulic bottom plate 207 of the compactor 200. Further, the figure shows the direction 208 of movement of the bottom plate 207, which is the depth direction in the case of FIG. 2a. Moreover, the vertical direction 209 of movement of the press member 206 is shown. The compressed bales 201 of material collected, produced and fed into the underground collection container 201 by the compactor 200, are also shown. The compactor 200 comprises all the structures and connections needed to secure the bottom plate 207 to the bottom part of the compactor 200 during the compressing, and to open the bottom plate 207, for dropping the material bale 210. The compactor 200 also comprises electrical connecting means for receiving e.g. an electrical wire or a plug for receiving an electrical wire. The electrical connecting means are not shown in this figure. FIG. 2a also shows the lifting eye 211 for emptying the collection container 201. FIG. 2a does not show the hatch or the filling opening of the waste compactor 200.

FIG. 2b shows a side view of the underground collection container 201 of FIG. 1, with the compactor 200. FIG. 2b shows the hatch of the waste compactor 200 in front of the filling opening of the compactor 200 (not shown). In FIG. 2b, the compactor 200 is not in the pressing state, and there is no material in its compressing space. In the embodiment shown in this FIG. 2b, the bottom plate 207 is open. The direction 208 of movement of the bottom plate 207 is shown here more clearly than in the front view of the embodiment of FIG. 2a. In FIG. 2b, broken lines show the location of the bottom plate 207 when it is closed. This is indicated with the reference numeral 213.

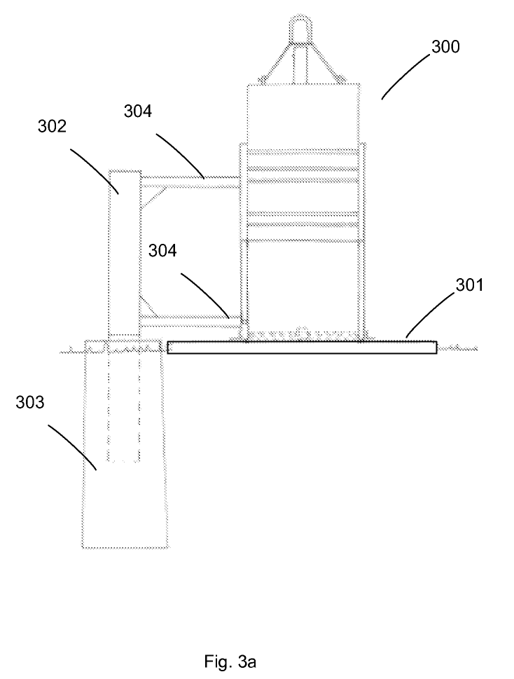

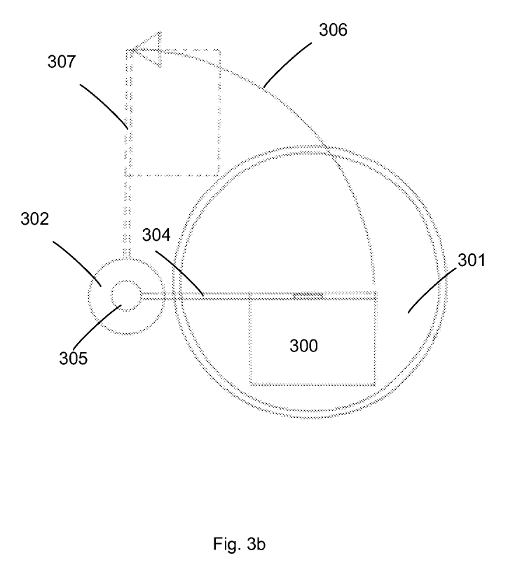

FIG. 3a shows a compactor 300 according to an embodiment of the invention fastened to the cover structure 301 of the underground collection container (not shown) in a detachable way. A support post 302 is provided next to the underground collection container. The support post 302 may be embedded in e.g. the ground by means of e.g. a concrete leg 303 or another supporting structure. The compactor 300 is pivotally connected to the support post 302 by means of two connecting arms 304. The connecting arms 304 are hinged to the post 302. The number of connecting arms can be only one or more than two as well. By means of this structure, the compactor can be transferred off the cover structure 301 for the time of emptying the underground collection container, and be returned onto the cover structure 301 after the emptying. By such an arrangement, the lifting up of the compactor is avoided when emptying the collection container. Particularly in the case of tall lifting containers, the length to be lifted becomes great if both the lifting receiver and the compactor with the cover structure have to be lifted.

FIG. 3b shows the operation of the fastening mechanism of a compactor according to an embodiment of the invention in a top view. FIG. 3b shows the compactor 300 fastened to a cover structure 301 by means of a fastening arm 304. FIG. 3b also shows hinges 305 constituting the connection between a support post 302 and the fastening arm 302. An arrow 306 indicates the path of the compactor 300 when it is moved off the cover structure 301, from the compressing position to the emptying position 307, that is, next to the cover structure 301.

It should be noted that when the quantity of waste material in the collection container, for example in an underground collection container, rises to a sufficiently high level, the press member can also press the recyclable material existing in the collection container downwards, to become more compact, when the hydraulic bottom plate is open. Thus, the press member is pressed via the bottom opening of the compactor, opened by the bottom plate, to compress the material already in the collection container simultaneously when a new compressed bale is fed into the collection container.

Moreover, it should be noted that the compactor may empty the compressing space after every compressing, or it may empty the compressing space when the mass accumulated in the pressing space reaches a sufficient height; that is, when the pressing member no longer goes to a sufficiently low level in the compressing space.

The compactor according to the invention may also comprise an emergency switch, that is, a safety switch or another corresponding switch for turning off the operation. The safety switch can be placed e.g. in the front panel of the compactor. In the case of an emergency, the safety switch will immediately turn off the operation of the device.

However, the compactor may also be used in underground collection containers with no lifting bag but merely a collection receiver. Moreover, the compactor may also be used for compacting a material other than cardboard or plastic, if necessary. However, a greater advantage is achieved by compacting when it is applied for recyclable materials which have so light weight that they are not automatically placed tightly in the collection container, or which can otherwise be compacted to a smaller volume by the compactor, examples including glass, garbage, metal fractions, energy waste, or mixed waste, such as waste from fast food restaurants, comprising a large volume of e.g. cardboard tableware.

It is obvious that the present disclosure is not limited to the above presented advantageous embodiments, but it may be varied within the scope of the appended claims.

1. Hydraulic compactor configured to be fastened to the cover structure of an underground collection container, for compressing waste materials, wherein the hydraulic compactor comprises a filling opening with a hatch, via which opening the waste material is entered into a compressing space inside the compactor, a press member being provided above the compressing space and being movable in the vertical direction inside the compactor and being configured to press the waste material fed into the compressing space against the bottom plate of the compactor, the bottom plate being a hydraulic bottom plate openable in the horizontal direction, via which bottom plate the waste material compressed by the press member is configured to be dropped into the underground collection container.

2. The compactor according to claim 1, the hatch being lockable, the press member starting to compress the waste material after the hatch of the compactor has been automatically locked or after the hatch of the compactor has been locked by applying a separate actuating switch.

3. The compactor according to claim 1, comprising a waste material limiting switch for triggering the opening of the hydraulic bottom plate.

4. An underground collection container comprising a hydraulic compactor according to claim 1.

5. The underground collection container according to claim 4, the underground collection container being totally embeddable below the surface of the ground.

6. The underground collection container according to claim 4, the underground collection container being configured to remain partly below the surface of the ground.

7. The underground collection container according to claim 4, the hydraulic compactor being fixed to the cover structure by at least one fixing member.

8. The underground collection container according to claim 4, the hydraulic compactor being fastened to the top of the cover structure.

9. The underground collection container according to claim 4, wherein part of the hydraulic compactor is in the underground collection container.

10. The underground collection container according to claim 4, wherein the lifting receiver comprised by the underground collection container is fastened to the hydraulic compactor in a fixed manner.
